(19) United States
(12) Patent Application Publication
(10) Pub. No.: US 2025/0183330 A1
(43) Pub. Date: Jun. 5, 2025

(54) SINGLE CELL FOR FUEL CELL, AND METHOD FOR DESIGNING SINGLE CELL FOR FUEL CELL

(71) Applicant: TOYOTA BOSHOKU KABUSHIKI KAISHA, Aichi-ken (JP)

(72) Inventors: Haruyuki AONO, Aichi-ken (JP); Satoshi KAWABE, Ichinomiya-shi (JP); Harutaka ODA, Toyota-shi (JP)

(73) Assignee: TOYOTA BOSHOKU KABUSHIKI KAISHA, Aichi-ken (JP)

(21) Appl. No.: 18/953,787

(22) Filed: Nov. 20, 2024

(30) Foreign Application Priority Data
Nov. 30, 2023 (JP) 2023-203142

(51) Int. Cl. H01M 8/026; H01M 4/88; H01M 8/00; H01M 8/0206

(52) U.S. Cl. CPC H01M 8/026; H01M 4/8807; H01M 4/881; H01M 8/006; H01M 8/0206

(57) ABSTRACT

A single cell for a fuel cell includes a membrane electrode assembly, two gas diffusion layers that sandwich the membrane electrode assembly, and two separators that sandwich the membrane electrode assembly and the two gas diffusion layers. The gas diffusion layer has a Young's modulus of greater than or equal to 1800 MPa and a thickness ranging from 0.12 mm to 0.25 mm, inclusive. Each separator includes a groove with a branching part. The groove forms a passage that supplies the reactant gas to the membrane electrode assembly. A value obtained by dividing a diameter of an inscribed circle of the branching part in the groove by a width of a general part in the groove is less than or equal to 2.5.

### CROSS-REFERENCE TO RELATED APPLICATIONS

This application is based upon and claims the benefit of priority from prior Japanese Patent Application No. 2023-203142, filed on Nov. 30, 2023, the entire contents of which are incorporated herein by reference.

### BACKGROUND

### 1. Field

The present disclosure relates to a single cell for a fuel cell and to a method for designing a single cell for a fuel cell.

### 2. Description of Related Art

Japanese Laid-Open Patent Publication No. 2022-182067 discloses an example of a single cell for a fuel cell. Such a single cell includes a membrane electrode assembly sandwiched between two gas diffusion layers, a frame member that supports the membrane electrode assembly, and two separators that sandwich the membrane electrode assembly. A groove passage is formed in each separator to supply reactant gas to the membrane electrode assembly.

In the single cell, the groove passage formed in the separator includes a branching part. The branching part in the groove passage is wider than other parts of the groove passage, making a portion of the gas diffusion layer in contact with the branching part more prone to deflection. As a result, a part of the membrane electrode assembly in contact with the portion of the gas diffusion layer more prone to deflection experiences a reduction in surface pressure and thus becomes more prone to swelling.

The membrane electrode assembly undergoes contraction and expansion due to repeated cycles of drying and humidification. The portion of the membrane electrode assembly where the surface pressure has decreased are deformed more easily due to contraction and expansion. Thus, the load increases on the portion of the membrane electrode assembly where the surface pressure has decreased, thereby reducing the durability of the membrane electrode assembly.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A single cell for a fuel cell according to an aspect of the present disclosure includes a membrane electrode assembly configured to generate power using reactant gas, two gas diffusion layers that sandwich the membrane electrode assembly, and two separators that sandwich the membrane electrode assembly and the two gas diffusion layers. The gas diffusion layer has a Young's modulus of greater than or equal to 1800 MPa and a thickness ranging from 0.12 mm to 0.25 mm, inclusive. Each of the separators includes a groove having a branching part. The groove forms a passage that supplies the reactant gas to the membrane electrode assembly. A value obtained by dividing a diameter of an inscribed circle of the branching part in the groove by a width of a general part is less than or equal to 2.5. The general part is a portion of the groove other than the branching part.

In a method for designing a single cell for a fuel cell according to an aspect of the present disclosure, the single cell includes a membrane electrode assembly configured to generate power using reactant gas, two gas diffusion layers that sandwich the membrane electrode assembly, and two separators that sandwich the membrane electrode assembly and the two gas diffusion layers. The method includes setting a Young's modulus of the gas diffusion layer to greater than or equal to 1800 MPa, setting a thickness of the gas diffusion layer to between 0.12 mm and 0.25 mm, inclusive, and designing each of the separators so as to include a groove having a branching part. The groove forms a passage that supplies the reactant gas to the membrane electrode assembly. The method also includes designing a shape of the groove such that a value obtained by dividing a diameter of an inscribed circle of the branching part in the groove by a width of a general part is less than or equal to 2.5. The general part is a portion of the groove other than the branching part.

Other features and aspects will be apparent from the following detailed description, the drawings, and the claims.

### BRIEF DESCRIPTION OF THE DRAWINGS

FIG. 1 is an exploded perspective view of a single cell according to an embodiment.

FIG. 2 is a schematic cross-sectional view illustrating the main part of the separator.

FIG. 3 is a schematic plan view illustrating the main part of the separator.

FIG. 4 is a cross-sectional view taken along line 4-4 in a state in which the gas diffusion layer is brought into contact with the separator shown in FIG. 3.

FIG. 5 is a graph illustrating the positional relationship between the deflection amount of the gas diffusion layer and the contact ratio of the gas diffusion layer.

FIG. 6 is a cross-sectional view taken along line 6-6 in FIG. 3.

FIG. 7 is a graph illustrating the relationship between the diameter-to-groove width ratio and the angle.

FIG. 8 is a graph illustrating the relationship between the diameter-to-groove width ratio and the branch angle.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment will now be described with reference to the drawings.

### Single Cell 11 for Fuel Cell

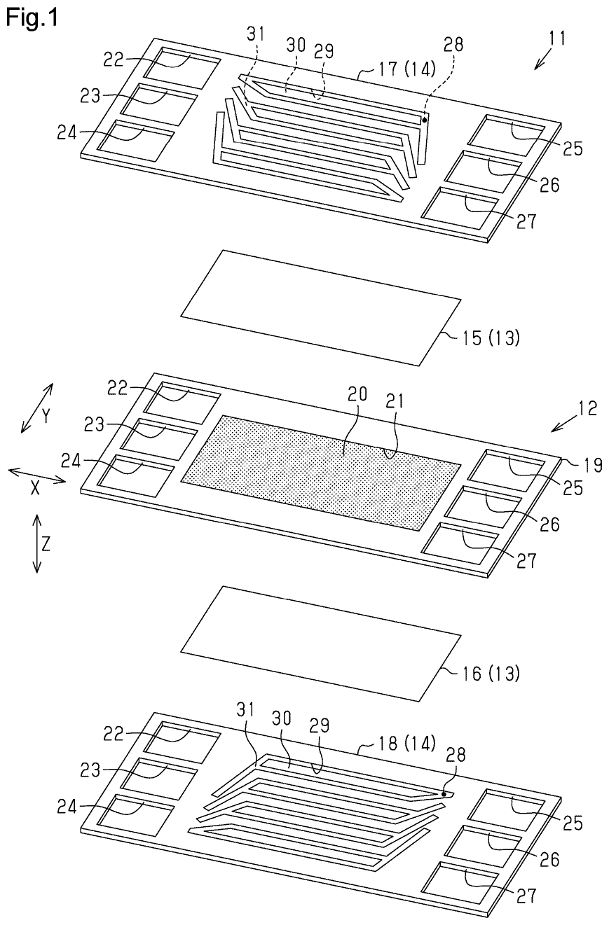

As shown in FIG. 1, a single cell 11 for a fuel cell has the shape of a rectangular plate. Multiple single cells 11 are stacked to form a fuel cell stack (not shown). The single cell 11 includes a power generation unit 12 having the shape of a rectangular plate, two gas diffusion layers 13 having the shape of a rectangular sheet, and two separators 14 having the shape of a rectangular plate. That is, the single cell 11 is structured such that the power generation unit 12 sandwiched between the two gas diffusion layers 13 is further sandwiched by the two separators 14 from the outside of the gas diffusion layers 13.

In the following description, the longitudinal direction, latitudinal direction, and thickness direction in the single cell 11 are referred to as the longitudinal direction X, latitudinal direction Y, and thickness direction Z, respectively. The longitudinal direction X, the lateral direction Y, and the thickness direction Z are orthogonal to each other.

As shown in FIG. 1, one of the two gas diffusion layers 13, on the cathode side, is referred to as the first gas diffusion layer 15, while the other, on the anode side, is referred to as the second gas diffusion layer 16. One of the two separators 14, on the cathode side, is referred to as the first separator 17, while the other, on the anode side, is referred to as the second separator 18.

The power generation unit 12 includes a resin frame member 19 having the shape of a rectangular plate, and a membrane electrode assembly 20 (MEA) that has the shape of a rectangular plate and is supported by the frame member 19. The frame member 19 has a rectangular opening 21 at its middle portion. The membrane electrode assembly 20 is bonded to the frame member 19 while being positioned in the opening 21. That is, the membrane electrode assembly 20 is supported by the frame member 19 while closing the opening 21.

The two gas diffusion layers 13 sandwich, in the thickness direction Z, the membrane electrode assembly 20 supported by the opening 21 of the frame member 19. The two separators 14 are located on the outside of the two gas diffusion layers 13 to sandwich the power generation unit 12 in the thickness direction Z. The two gas diffusion layers 13 are set to have a thickness ranging from 0.12 mm to 0.25 mm, inclusive, and a Young's modulus of 1800 MPa or greater.

In the single cell 11, oxidant gas containing oxygen is supplied to one side (cathode side) of the membrane electrode assembly 20 in the thickness direction Z, and fuel gas containing hydrogen is supplied to the other side (anode side) of the membrane electrode assembly 20 in the thickness direction Z. As a result, the single cell 11 generates power based on the electrochemical reaction of the oxidant gas and the fuel gas in the membrane electrode assembly 20. That is, the membrane electrode assembly 20 generates power using oxidant gas and fuel gas as reactant gas.

### Passage Structure in Single Cell 11

As shown in FIG. 1, the opposite ends of the single cell 11 that sandwich the membrane electrode assembly 20 in the longitudinal direction X, i.e., the opposite ends of the frame member 19 and the two separators 14 that sandwich the membrane electrode assembly 20 in the longitudinal direction X, each have three rectangular through-holes arranged in the lateral direction Y.

The three through-holes at one end of the single cell 11 in the longitudinal direction X are referred to as the oxidant gas supply hole 22, the cooling medium supply hole 23, and the fuel gas discharge hole 24. The three through-holes at the other end of the single cell 11 in the longitudinal direction X are referred to as the fuel gas supply hole 25, the cooling medium discharge hole 26, and the oxidant gas discharge hole 27. In this case, in the longitudinal direction X, the oxidant gas supply hole 22 is aligned with the fuel gas supply hole 25, the cooling medium supply hole 23 is aligned with the cooling medium discharge hole 26, and the fuel gas discharge hole 24 is aligned with the oxidant gas discharge hole 27.

The fuel gas supply hole 25 is included in an inlet-side fuel gas manifold, where fuel gas is supplied, in the fuel cell stack. The fuel gas discharge hole 24 is included in an outlet-side fuel gas manifold, where fuel gas is discharged, in the fuel cell stack. The oxidant gas supply hole 22 is included in an inlet-side oxidant gas manifold, where oxidant gas is supplied, in the fuel cell stack.

The oxidant gas discharge hole 27 is included in an outlet-side oxidant gas manifold, where oxidant gas is discharged, in the fuel cell stack. Each manifold extends in the stacking direction (thickness direction Z) of multiple single cells 11 when forming the fuel cell stack.

An oxidant gas passage is formed between the frame member 19 and the membrane electrode assembly 20 on one side, and the first separator 17 on the other to supply, through the membrane electrode assembly 20 to the oxidant gas discharge hole 27, the oxidant gas that has been supplied from the oxidant gas supply hole 22. A fuel gas passage is formed between the frame member 19 and the membrane electrode assembly 20 on one side, and the second separator 18 on the other to supply, through the membrane electrode assembly 20 to the fuel gas discharge hole 24, the fuel gas that has been supplied from the fuel gas supply hole 25.

When multiple single cells 11 are stacked to form the fuel cell stack, a cooling medium passage (not shown) is formed between the first separator 17 of one of two adjacent single cells 11 and the second separator 18 of the other in the stacking direction (thickness direction Z). The cooling medium passage supplies, to the cooling medium discharge hole 26, the cooling medium that has been supplied from the cooling medium supply hole 23.

### Separators 14

As shown in FIG. 1, the first separator 17 and the second separator 18 have identical structures, and thus will be described collectively as the separator 14. The first separator 17 and the second separator 18 are arranged in the single cell 11 such that their front and back sides are reversed relative to each other. The above-described oxidant gas passage and fuel gas passage are described as the passages 28, which supply reactant gas to the membrane electrode assembly 20.

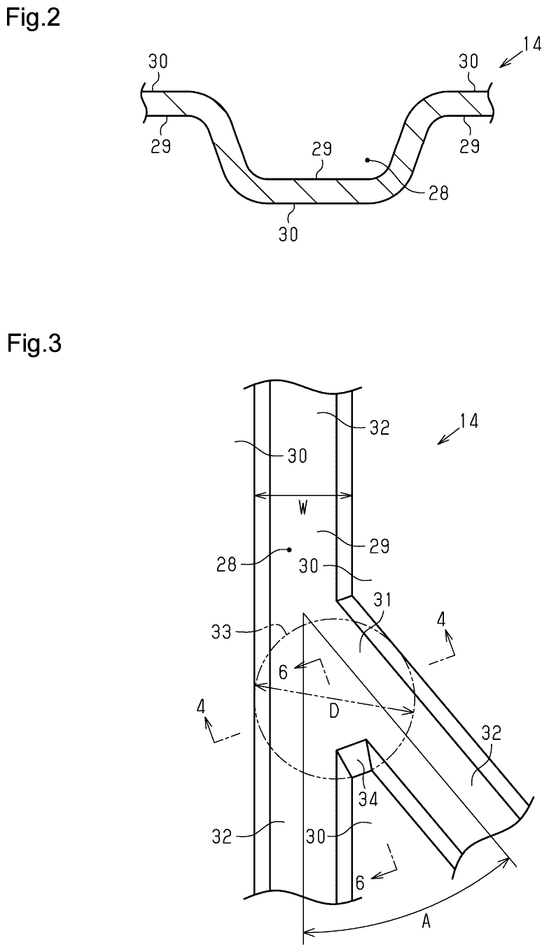

As shown in FIGS. 1 and 2, the passage 28 includes protrusions and recesses that are integrally formed on both front and back sides by pressing the separator 14. That is, the passage 28 is formed by a groove 29 that is a recessed portion of the protrusion and recess of the separator 14, facing the membrane electrode assembly 20. The protruding portion of the protrusion and recess of the separator 14, facing the membrane electrode assembly 20, is a rib 30. In the present embodiment, the protrusion and recess forming the passage 28 and the rib 30 of the separator 14 have a substantially trapezoidal shape in a cross-sectional view.

The grooves 29, forming the passages 28 in the separator 14, each have a branching part 31 where one path splits into two. The grooves 29, forming the passages 28 in the separator 14, extend in parallel with each other at regular intervals. The rib 30 is formed between adjacent ones of the grooves 29 in the separator 14. In the separator 14, the groove 29 on the surface of one side forms the rib 30 on the surface of the other side, and the rib 30 on the surface of one side forms the groove 29 on the surface of the other side.

The separator 14 is made of material such as aluminum, titanium, stainless steel, or carbon-fiber reinforced plastic (CFRP).

### Detailed Structure of Groove 29 of Separator 14

As shown in FIGS. 1 to 3, the groove 29 of the separator 14 includes the branching part 31 and general parts 32, which are the portions other than the branching part 31. The groove 29 of the separator 14 is configured such that the value obtained by dividing a diameter D of an inscribed circle 33 of the branching part 31 by a groove width W of each general part 32 is set to less than or equal to 2.5. That is, the groove 29 of the separator 14 is configured such that the diameter D of the inscribed circle 33 of the branching part 31 is set to less than or equal to 2.5 times the groove width W of the general part 32.

For example, when the groove width W is 1, the diameter D is set to less than or equal to 2.5. When the groove width W is 0.9, the diameter D is set to less than or equal to 2.25. When the groove width W is 0.8, the diameter D is set to less than or equal to 2.0. In these examples, the ratio of the diameter D to the groove width W is consistently 2.5 as shown by (2.5/1), (2.25/0.9), and (2.0/0.8). In the present embodiment, the ratio of the diameter D to the groove width W is set to, for example, approximately 1.7.

The reasons for setting the above-described ratio of the diameter D to the groove width W to less than or equal to 2.5 will now be described.

As shown in FIGS. 3 to 5, the experiment results reveal that a deflection amount T of the gas diffusion layer 13 in the groove 29, when the gas diffusion layer 13 is brought into contact with the separator 14, is less than or equal to 21 um as the quality required to improve the durability of the membrane electrode assembly 20. The graph of FIG. 5 reveals that the deflection amount T is less than or equal to 21 um when a contact ratio C of the gas diffusion layer 13 relative to the region of the separator 14 including the branching part 31 and the ribs 30, which sandwich the branching part 31, is greater than or equal to 0.48.

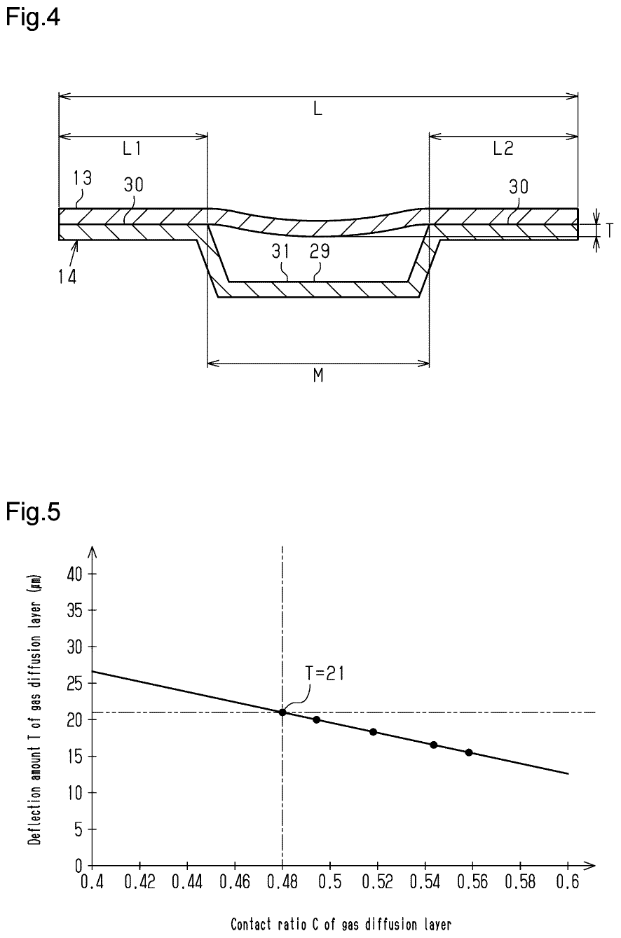

The contact ratio C is determined by (L1+L2)/L. In FIGS. 4, L1 and L2 represent portions of the separator 14 that are in contact with the gas diffusion layer 13 (i.e., the ribs 30), M represents a portion of the separator 14 that is not in contact with the gas diffusion layer 13 (i.e., the branching part 31), and L represents the sum of L1, L2, and M.

The ratio of the diameter D to the groove width W is 2.5 when the contact ratio C is 0.48. Thus, when the ratio of the diameter D to the groove width W is set to less than or equal to 2.5, the contact ratio C is greater than or equal to 0.48. That is, when the ratio of the diameter D to the groove width W is set to less than or equal to 2.5, the deflection amount T is less than or equal to 21 μm.

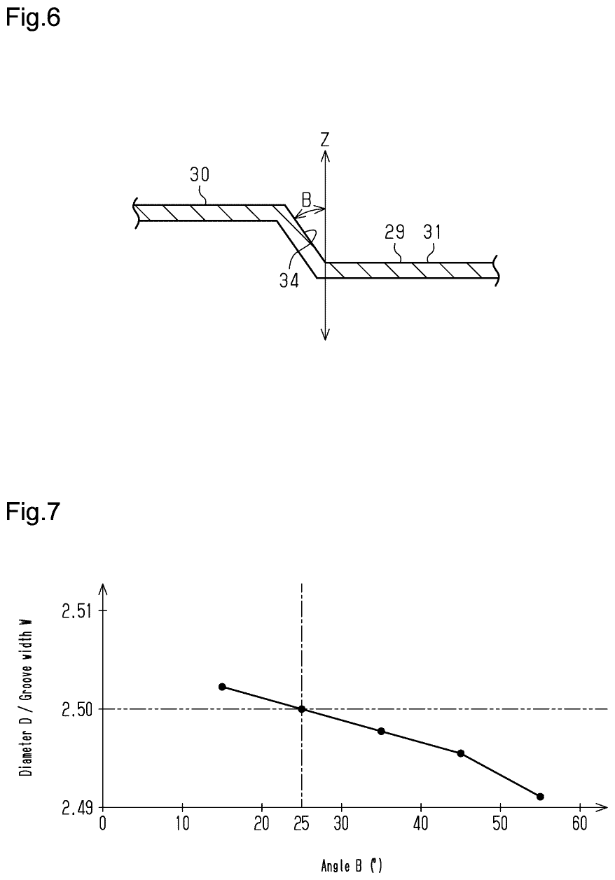

As shown in FIGS. 3, 6, and 7, it is preferred that a side surface 34 of the branching part 31 of the groove 29 in the separator 14 is inclined at an angle B of greater than or equal to 25° and less than 90° with respect to the thickness direction Z of the separator 14. The side surface 34 is located at the junction of two grooves 29 that split at the branching part 31.

The reasons for setting the angle B to greater than or equal to 25° are that when the angle B is greater than or equal to 25°, the ratio of the diameter D to the groove width W is less than or equal to 2.5, as shown in the graph of FIG. 7. The reasons for setting the angle B to less than 90° are that when the angle B is 90°, the side surface 34 of the branching part 31 would no longer exist. In the present embodiment, the angle B is set to, for example, approximately 35°.

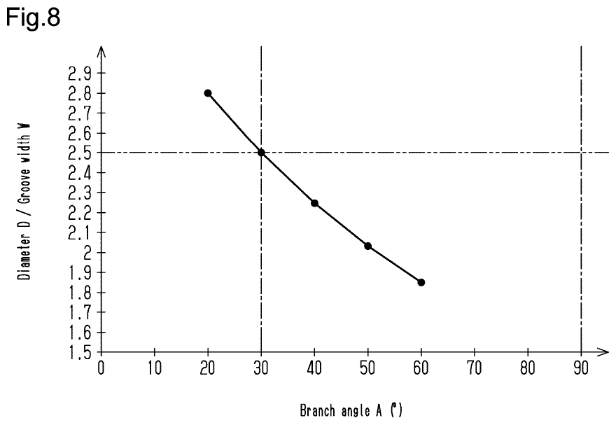

As shown in FIGS. 3 and 8, it is preferred that a branch angle A at the branching part 31 of the groove 29 in the separator 14 is within the range of 30° to 90°, inclusive. The reasons for setting the branch angle A to between 30° and 90°, inclusive, are that when the branch angle A is within the range of 30° to 90°, inclusive, the ratio of the diameter D to the groove width W is less than or equal to 2.5 as shown in the graph of FIG. 8. In the present embodiment, the branch angle A is set to, for example, approximately 40°.

The method for designing the single cell 11 includes setting the thickness of the gas diffusion layer 13 to between 0.12 mm and 0.25 mm, inclusive. The method also includes setting the Young's modulus of the gas diffusion layer 13 to greater than or equal to 1800 MPa. The method further includes designing the shape of the groove 29 of the separator 14 such that the ratio of the diameter D to the groove width W is less than or equal to 2.5, the branch angle A is between 30° and 90°, inclusive, and the angle B is greater than or equal to 25° and less than 90°.

### Operation of Embodiment

When the single cell 11 generates power, oxidant gas is supplied from the oxidant gas supply hole 22, and fuel gas is supplied from the fuel gas supply hole 25. In the single cell 11, oxidant gas is supplied from the oxidant gas supply hole 22. Then, in the process of flowing through the oxidant gas passage to the oxidant gas discharge hole 27, the oxidant gas is supplied to the cathode-side surface of the membrane electrode assembly 20 while being diffused by the first gas diffusion layer 15.

In the single cell 11, fuel gas is supplied from the fuel gas supply hole 25. Then, in the process of flowing through the fuel gas passage to the fuel gas discharge hole 24, the fuel gas is supplied to the anode-side surface of the membrane electrode assembly 20 while being diffused by the second gas diffusion layer 16. Then, the single cell 11 generates power from the electrochemical reaction in the membrane electrode assembly 20 between the oxidant gas supplied to the cathode-side surface of the membrane electrode assembly 20 and the fuel gas supplied to the anode-side surface of the membrane electrode assembly 20. During power generation, product water is generated on the cathode side of the membrane electrode assembly 20.

In the groove 29 of the separator 14 of each of the single cells 11 included in the fuel cell stack, the branching part 31 is wider than the general parts 32, making the portion of the gas diffusion layer 13 in contact with the branching part 31 more prone to deflection. As a result, the part of the membrane electrode assembly 20 in contact with the portion of the gas diffusion layer 13 more prone to deflection experiences a reduction in surface pressure and thus becomes more prone to swelling.

The membrane electrode assembly 20 undergoes contraction and expansion due to repeated cycles of drying and humidification that result from humidity changes due to power generation. The portion of the membrane electrode assembly 20 where the surface pressure has decreased are deformed more easily due to contraction and expansion. As a result, the load increases on the portion of the membrane electrode assembly 20 where the surface pressure has decreased, thereby reducing the durability of the membrane electrode assembly 20.

In the single cell 11 of the present embodiment, the gas diffusion layer 13 has a Young's modulus of greater than or equal to 1800 MPa and a thickness ranging from 0.12 mm to 0.25 mm, inclusive. Further, the value obtained by dividing the diameter D of the inscribed circle 33 of the branching part 31 in the groove 29 of the separator 14 by the groove width W of the general part 32, which is other than the branching part 31 in the groove 29, is less than or equal to 2.5.

Thus, as described above in the section of Detailed Structure of Groove 29 of Separator 14, the deflection amount T of the gas diffusion layer 13 in the groove 29, when the gas diffusion layer 13 is brought into contact with the separator 14, is less than or equal to 21 μm. This limits the deformation of the portion of the membrane electrode assembly 20 corresponding to the branching part 31, thereby reducing the load on that portion. As a result, the durability of the membrane electrode assembly 20 is improved, and consequently, the durability of the single cell 11 is enhanced.

### Advantages of Embodiment

The embodiment described above in detail has the following advantages.
(1) The single cell 11 includes the membrane electrode assembly 20, which generates power using reactant gas, the two gas diffusion layers 13, which sandwich the membrane electrode assembly 20, and the two separators 14, which sandwich the membrane electrode assembly 20 and the two gas diffusion layers 13. The gas diffusion layer 13 has a Young's modulus of greater than or equal to 1800 MPa and a thickness ranging from 0.12 mm to 0.25 mm, inclusive. The separator 14 includes the groove 29, which has the branching part 31 and forms the passage 28. The passage 28 supplies reactant gas to the membrane electrode assembly 20. The value obtained by dividing the diameter D of the inscribed circle 33 of the branching part 31 in the groove 29 by the groove width W of the general part 32, which is a portion other than the branching part 31 in the groove 29, is less than or equal to 2.5.

This configuration improves the durability of the membrane electrode assembly 20 as described above in the section of Operation of Embodiment.
(2) In the single cell 11, the branch angle A at the branching part 31 of the groove 29 is between 30° and 90°, inclusive. Further, the side surface 34 of the branching part 31 of the groove 29 is inclined by the angle B of greater than or equal to 25° and less than 90° with respect to the thickness direction Z of the separator 14.

This configuration further improves the durability of the membrane electrode assembly 20 as described above in the section of Detailed Structure of Groove 29 of Separator 14.

### Modifications

The above-described embodiment may be modified as follows. The above-described embodiment and the following modifications can be combined as long as the combined modifications remain technically consistent with each other.

The branch angle A at the branching part 31 of the groove 29 does not have to be between 30° and 90°, inclusive.

The side surface 34 of the branching part 31 of the groove 29 does not have to be inclined by the angle of greater than or equal to 25° and less than 90° with respect to the thickness direction Z of the separator 14.

The passage 28 may be formed by a groove 29 that has been formed by machining the separator 14.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A single cell for a fuel cell, the single cell comprising:
a membrane electrode assembly configured to generate power using reactant gas;
two gas diffusion layers that sandwich the membrane electrode assembly; and
two separators that sandwich the membrane electrode assembly and the two gas diffusion layers, wherein
the gas diffusion layer has a Young's modulus of greater than or equal to 1800 MPa and a thickness ranging from 0.12 mm to 0.25 mm, inclusive,
each of the separators includes a groove having a branching part, the groove forming a passage that supplies the reactant gas to the membrane electrode assembly, and
a value obtained by dividing a diameter of an inscribed circle of the branching part in the groove by a width of a general part is less than or equal to 2.5, the general part being a portion of the groove other than the branching part.

2. The single cell for the fuel cell according to claim 1, wherein
a branch angle at the branching part of the groove is between 30° and 90°, inclusive, and
a side surface of the branching part of the groove is inclined by an angle of greater than or equal to 25° and less than 90° with respect to a thickness direction of the separators.

3. A method for designing a single cell for a fuel cell, the single cell including a membrane electrode assembly configured to generate power using reactant gas, two gas diffusion layers that sandwich the membrane electrode assembly, and two separators that sandwich the membrane electrode assembly and the two gas diffusion layers, the method comprising:
setting a Young's modulus of the gas diffusion layer to greater than or equal to 1800 MPa;
setting a thickness of the gas diffusion layer to between 0.12 mm and 0.25 mm, inclusive; and
designing each of the separators so as to include a groove having a branching part, the groove forming a passage that supplies the reactant gas to the membrane electrode assembly; and
designing a shape of the groove such that a value obtained by dividing a diameter of an inscribed circle of the branching part in the groove by a width of a general part is less than or equal to 2.5, the general part being a portion of the groove other than the branching part.

4. The method for designing the single cell for the fuel cell according to claim 3, further comprising:
designing the shape of the groove such that the branching part of the groove has a branch angle between 30° and 90°, inclusive, and a side surface of the branching part of the groove is inclined by an angle of greater than or equal to 25° and less than 90° with respect to a thickness direction of the separators.
